(19) United States
(12) Patent Application Publication
(10) Pub. No.: US 2004/0172291 A1
(43) Pub. Date: Sep. 2, 2004

(54) System and methods for medical services and transactions

(76) Inventor: Edward W. Knowlton, Zephyr Cove, NV (US)

Correspondence Address: Joel M. Harris, 1027 Solana Drive, Mountain View, CA, 94040, US

(21) Appl. No.: 10/626,977

(22) Filed: Jul. 25, 2003

Related U.S. Application Data
(60) Provisional application No. 60/398,371, filed on Jul. 25, 2002.

(51) Int. Cl. G06F 17/60

(52) U.S. Cl. 705/2

(57) ABSTRACT

An embodiment of the invention provides a system for processing medical service contracts transactions comprising a processor, an interface module coupled to one of the processor or a network; and a medical service contract module coupled to at least one of the interface module, or the processor. The contract module is configured to be coupled to a contract matrix having a plurality of medical service contracts. The contract module is also configured to perform at least one of a contract selection function, a contract generation function or a contract execution function between a plurality of parties. The generation function includes the generation of a contract having a selectable medical service parameter, wherein the contract module utilizes the contract matrix to perform the contract selection, generation or execution responsive to at least one of a patient medical, financial or insurance input.

### RELATED APPLICATIONS

This application claims the benefit of priority to U.S. Provisional Application Serial No. 60/398,371, filed Jul. 25, 2002, entitled “System And Methods For Medical Services And Transactions” which is fully incorporated by reference herein.

### FIELD OF THE INVENTION

Embodiments of the invention relate to a method of providing services to a medical practitioner and a patient. More particularly, embodiments of the invention relate to a method of providing services to a medical practitioner and a patient on a network based system such as the Internet.

### BACKGROUND OF THE INVENTION

The preparation and processing of health care transactions such as medical insurance claims, physician reimbursement and patient enrolment and reimbursement procedures involves transactions between multiple parties. There is a need for better systems for the processing of these and other health care transactions.

### SUMMARY OF THE INVENTION

Embodiments of the invention provide a method and system for providing a menu of services to a medical practitioner or physician group by a service company or other organization using a processor, a computer or other computational means, or a computer network or other electronic network known in the art. Other aspects of the invention can include methods for performing or otherwise facilitating the patient referral and enrolment process.

An embodiment of the invention provides a method of delivering service to and collection of fees for and from a medical practitioner by another party, organization or corporation.

Another embodiment of the invention provides a system and method for electronically entering into an agreement, such as a license, for the use of a proprietary or patented medical procedure by a medical practitioner. The system can be configured to select the agreement responsive to a selected medical service contract or medical procedure. The system can also be configured to select agreement parameters such as number of uses and calculate licensing and or fees.

Still another embodiment of the invention provides a system and method of signaling an agreement, such as a license, for the use of a proprietary or patented medical procedure by a medical practitioner wherein the agreement is signaled between a party such as a service corporation and the medical practitioner.

Yet another embodiment provides a method of administration of a health care plan between a participating third party carrier and a client employer. Other aspects of the invention can include methods for a service organization or entity to provide online medical education, assistance as well as financial representation of the patient.

Still another embodiment provides a system for processing medical service contracts transactions comprising a processor, an interface module coupled to one of the processor or a network; and a medical service contract module coupled to at least one of the interface module, or the processor. The contract module is configured to be coupled to a contract matrix having a plurality of medical service contracts. The contract module is also configured to perform at least one of a contract selection function, a contract generation function or a contract execution function between a plurality of parties. The generation function includes the generation of a contract having a selectable medical service parameter, wherein the contract module utilizes the contract matrix to perform the contract selection function, generation function or execution function responsive to at least one of a patient medical, financial or insurance input.

Another embodiment provides a system for processing medical transactions including a financial data module comprising a plurality of financial data stored therein. A financial transaction processing module is coupled to the financial data module and an interface module is coupled to the transaction processing module. The interface module is configured to be coupled to a network.

Another embodiment provides a system for processing medical business transactions including a financial data module comprising a plurality of financial data stored therein. A financial transaction processing module is coupled to the financial data module. An interface module is coupled to the transaction processing module. The interface module is configured to be coupled to a distributed network. A contract module is coupled to the interface module and is configured to perform one of a contract selection, modification or execution function. A medical database module is coupled to one of the interface module or the contract module. The medical database module is configured to store a medical record.

Still another embodiment provides a method for processing medical transactions including the signaling of data between a first party and a second party, wherein the data includes at least one of financial, medical or insurance data. A medical service contract is then generated having a medical service parameter. The contract generation can be done utilizing at least one of a contract matrix or contract module configured to allow multiple groups of parties to enter into contract for the delivery of medical service to a patient. The contract generation is responsive to at least one of the financial data, the medical data or the insurance data. The contract is then signaled between the first party and the second party. The contract is then executed utilizing at least one of the module, the processor or the network.

Still another embodiment provides a method for enrolling a patient into a medical service plan including creating a patient electronic file having a plurality of records and entering at least one of medical, financial or insurance data into a record of the plurality of records. A medical service contract is then selected from a contract matrix using a contract module, the selection being responsive to at least one of the medical, financial or insurance data. The contract is then executing between the patient and a medical service provider utilizing the module. The executed contract is then signaled to at least one of the patient, the medical service provider or another party.

### BRIEF DESCRIPTION OF THE DRAWINGS

FIG. 1 is a block diagram illustrating an embodiment of a medical transaction system that can be used in conjunction with various methods of the invention.

FIG. 2a illustrates a contract matrix that can be used as a checklist for contract selection.

FIG. 2b is a block diagram illustrating of an embodiment for signaling a contract between one or more parties such as a physician patient, etc.

FIG. 3 is a process flow chart illustrating an embodiment of the reimbursement process

FIG. 4 is a block diagram illustrating an embodiment of a method for the physician or physician's representative to register a patient and generate a medical service contract.

FIG. 5 is a block diagram illustrating an embodiment of a method for the company representative to register a patient, physician or medical facility and check on reimbursement status.

FIG. 6 illustrates the use of fields that can be used and displayed on web pages that can be used with the embodiments of FIGS. 4 and 5 and other embodiments configured for Internet usage or implementation.

FIG. 7 is a flow chart illustrating an embodiment of method for enrolling a new patient.

### DETAILED DESCRIPTION

An embodiment of the invention provides a method of providing a menu of services to a medical practitioner or physician group by a service company or other organization using electronic, network, computer, digital means and the like. The medical practitioner or group, also called the healthcare or service provider, can be an independent individual or group having no affiliation with a particular hospital, HMO or health plan or they can various levels of affiliation with one or more of these entities. The service company (herein after “SC”), also called the company, can be an independent organization having no affiliation with a particular physician, physician group, hospital, HMO, insurance company or health plan and the like or it can have various levels of affiliation with one or more of these entities. As used herein, the medical practitioner can be, without limitation, a medical doctor, a physician, a surgeon, a doctor of osteopathy, a dentist, a chiropractor or other medical practitioner known in the art. Also in various embodiments, the SC can be incorporated, a partnership, a limited partnership, a limited liability partnership, a public corporation, a private corporation, a proprietorship and combinations thereof.

In various embodiments, the services provided to the medical practitioner or group can include but are not limited to: the patient referral process, fee calculation, fee collection, reimbursement including third party reimbursement, patient eligibility, medical procedures, patient-physician and patient care contracts, physician insurance company contracts, patient referrals, IPA (Independent Physician Association) agreements, IPA management and combinations thereof.

Another embodiment of the invention involves a method of delivering service to and collection of fees for a medical practitioner by another party, organization or corporation. Other related embodiments of the invention can include methods for performing or otherwise facilitating the patient referral process. This can include without limitation referral of a patient from the SC to a physician, from a first physician to a second physician, from a hospital to a physician, from an insurance plan to a physician, from a physician group to a physician, self referral and the like. Another embodiment provides a method of administration of a health care plan between a participating third party carrier and a client employer.

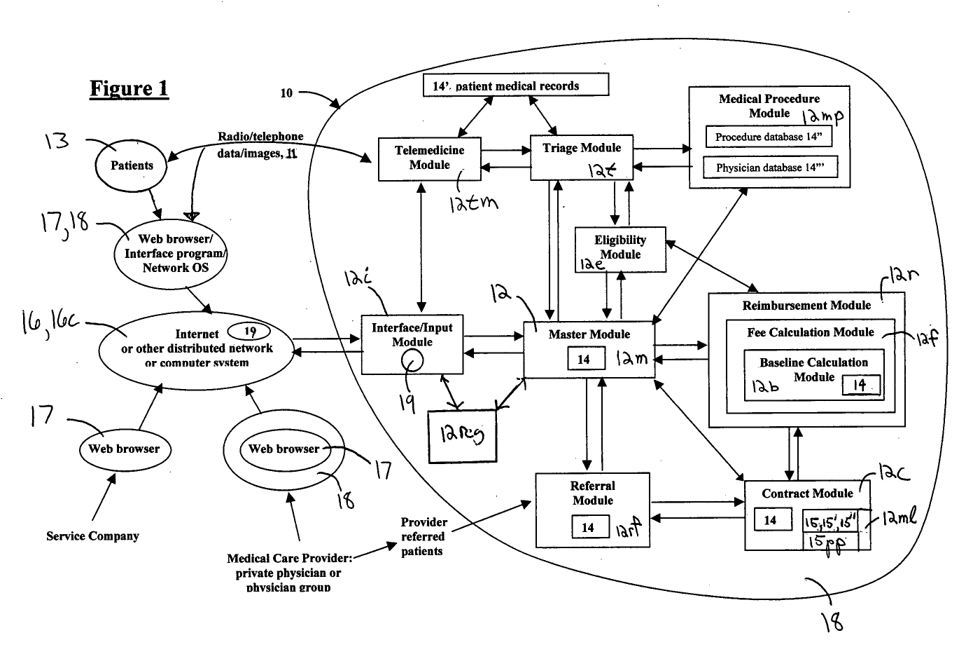

Referring now to FIG. 1, in various embodiments one, or more methods of the invention can be implemented over a network 16 or other electromagnetic communication means 16c using a medical transaction system 10. In various embodiments, system 10 can be a processor, computer, network, carrier wave or optical based system. System 10 can include, or be configured to include, a computer, a personal computer, a server, networked computers, a microprocessor chip set, ASIC or other logic resources and the like. Example processors can include Intel® Pentium® or Itanium®-based microprocessor or a Motorola® Power PC® chip or a RISC based processor. Also in various embodiments, system 10 can include one or more modules 12 that include electronic algorithms or instruction sets for performing one or more functions or operations of system 10. Such functions can include all or portion of various methods of the invention described herein such as patient enrolment, contract selection and physician reimbursement.

Network or communication means 16c can include without limitation, a computer network, a local area network, a wide area network, a TCP/IP network, the Internet, the World Wide Web or other distributed network, an optical network, a phone system or a wireless based phone system (an example being a cellular phone system).

For Internet and related configurations of system 10, the system can be accessed via a web browser 17 known in the art using a personal computer or other internet access device 18 known in the art (e.g., a PDA or cellular phone). Example web browsers can include various versions of Netscape® Navigator®, Netscape Communicator®, and Microsoft® Internet Explorer®. A user 13 of system 10 can utilize web browser 17 to access the system including modules 12 by entering a URL (universal resource locater) into web browser 17 to access a website 19 and/or module 12 on system 10. Websites 19 can be located on a web server or interface module 12i described herein. In various embodiments users 13 can include, without limitation, patients, medical practitioners, surgeons, nurse practitioners, contracting parties, the SC, their representatives and the like.

In various embodiments, modules 12 can include programs, subroutines, algorithms or algorithmic instructions stored on magnetic, optical or other storage media or storage resources known in the art. Module 12 can also include, without limitation, an object oriented program, a subroutine, a fuzzy logic routine, a portion of a program, or a hardware component capable of performing a stated task, function or algorithm. In various embodiments, a module 12 can exist only on a single hardware component, such as a server, independently of other modules. Alternatively, a module can exist and interact with other modules on the same server or within the same program or on multiple servers, workstations or nodes of a distributed electronic network. Further a module 12 can be a subroutine, a nested subroutine, subprogram, call-up function or object-oriented subprogram, and the like of another module. One or more modules may contain multiple nested modules or otherwise integral sub-modules. FIG. 1 illustrates the function and relationships of one or more such modules 12 employed by various embodiments of system 10.

In various embodiments, system 10 and/or modules 12 can be configured to perform one or more of the following functions: (i) transfer of contracts between at least one of the SC, Payer, patient or physician vial e-mail, facsimile or other electromagnetic communication means, (ii) data acquisition concerning the a) patient, his/her insurance policy, diagnosis & treatment, b) the provider and c) Payer; (iii) database management of information which can include the use of a lookup table, matrix or checklist to determine the correct set of contracts and a coupled set of contracts; and (iv) database management of receivables, collections, payables and the like.

Modules 12 can include a master module 12m coupled to other modules 12 described herein. Master module 12m can include call up functions or routines known in the art for engaging other modules 12. Other modules 12 can include without limitation, a contract module 12c for selecting, modifying and/or executing contracts; an interface module 12i for communicating between modules 12 and a network such as the Internet; an eligibility module 12e for determining/calculating patient eligibility; a reimbursement module 12r for performing or facilitating physician/health care provider reimbursements; a fee calculation module 12f which can include a baseline fee calculation module 12b; a referral module 12rf for handling or facilitating patient and/or physician referrals; a medical procedure module 12mp for facilitating, determining or licensing appropriate procedures or storing medical procedure data; a triage module 12t for performing a triage or prioritization function of incoming patient calls or emails requesting medical services; and a telemedicine module 12tm for communication of patient data, vital signs, images etc. In an embodiment, Interface module 12i can be a web server known in the art and can support one or more websites 19.

In various embodiments, one or more modules 12 can be interfaced with a database 14 (such as a patient database 14), which itself can comprise a module 12 or electronic or optical data storage medium, or other data storage device known in the art. Examples of data storage devices include but are not limited to hard drives, zip drives, PCMCIA cards, ROMs, CD ROMs and other optical storage devices known in the art. Databases 14 can include but are limited a medical record database 14′, a medical procedure database 14″, a physician database 14′″ and combinations thereof. In an embodiment, database 14 can be a relational database known in the art. In still other embodiments, system 10 can be configured to implement one or more methods of the invention (e.g., contract selection and execution) directly between a company or organization and the medical practitioner without the use of a hard-wired computer network. An example would include a method implemented over a phone system, cellular phone system, wireless PDA system, or other wireless or cellular communications system known in the art.

Another embodiment of the invention can include a telemedicine module 12tm configured for providing a telecommunication (e.g. phone, radio, carrier wave and the like) link or electronic network (e.g. the Internet) link between the physician and the SC, the SC and the patient or the physician and the patient or any one of these entities and another entity. An example of such a module is shown in FIG. 1. In various embodiments the telemedicine module 12tm or link can be configured to transmit patient data 11 including, but not limited to, medical images (e.g. ultrasound, x-ray, ct scans, mri, and the like) and patient vital signs and statistics (e.g. EKG, EEG, respiration rate, heart rate, heart sounds, fetal heart sounds, blood pressures and the like) both real-time and stored or a combination of both. A related embodiment provides a method to utilize a medical provider's portable device or PDA and associated database system configured to collect, store, and report historical patient-care information at the site of patient service or remotely at another site including the nurse practitioner's or physician's office or home, the service provider's office or the service company's office. These and related embodiments can be configured to allow the physician, or other health care-provider, to access and record not only patient status information, but other patient-treatment information as well, including but not limited to, prior and current medications, medical history, blood type, allergies, genetic data and genetic markers and the like. Various embodiments of the invention can also include one or more modules for performing, or facilitating all or a portion of the patient referral process. Genetic markers can include markers for disease predisposition (e.g. via the p53 gene), drug effectiveness and drug resistance.

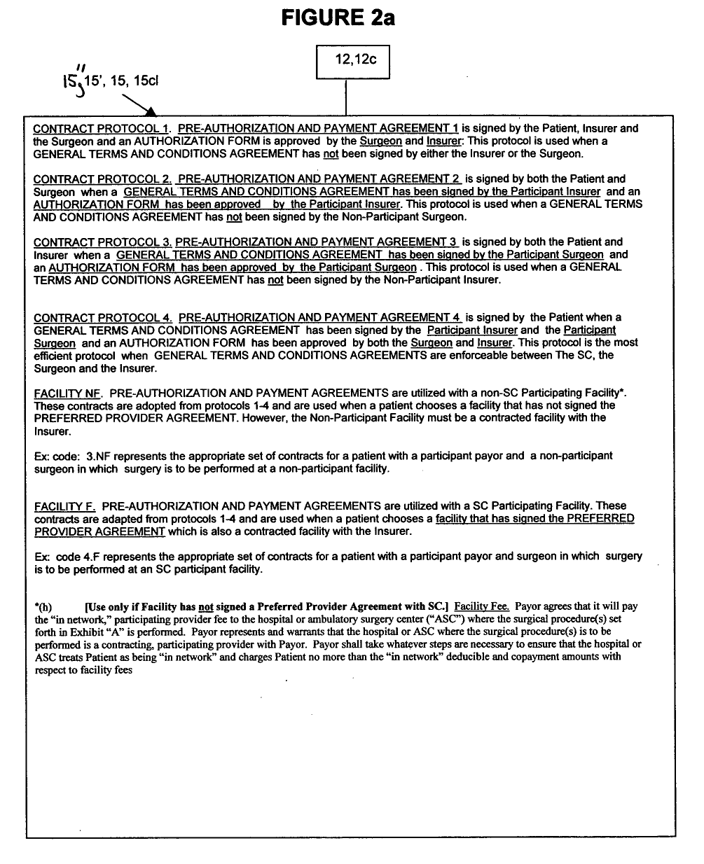

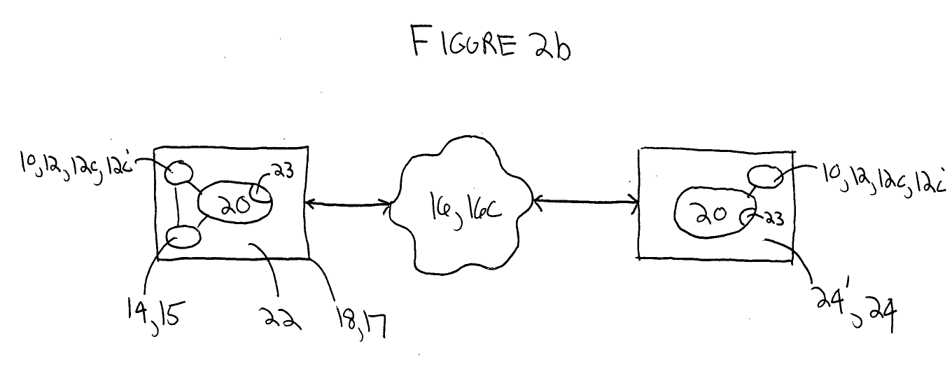

Embodiments of the invention can comprise a method of electronically communicating and/or executing contracts between two or more parties including, but not limited to, the patient, the healthcare or service provider, the payee, the SC and combinations thereof. This can be accomplished using a contract module 12c with one or more algorithms configured for generating, exchanging, completing, authenticating or executing all or portions of a contract and combinations thereof. The contracts can include without limitation a patient service contract, health care provider contracts and other contracts described herein. The contracts can be integral or electronically coupled to contact module 12c, other module 12 or database 14. In an embodiment, the contracts can be contained in a separate contract database 15 coupled to module 12c. Database 15 can include or be coupled to a contract matrix 15′ that can have a contract architecture 15″. An example of the content of the contract matrix is shown in FIG. 2a. Contract module 12c can, be configured to use the contract matrix 15′ to select the appropriate contract to utilize based on input signaled from one or more users 13 (e.g. patient, health care provider, etc) of system 10. Examples of input can include without limitation: i) medical input including, the patient medical profile, medical history, conditions, operations, allergies, medications, etc; ii) financial input including credit history, incomes level, credit/debit accounts; and iii) insurance input including insurance plan (e.g. group, etc.), insurance carrier, type of insurance, deductibles, co-payments, per cent payment, maximum payments, covered procedures and conditions and the like.

In an embodiment, contract matrix 15′ can be configured as an online contract database that can function as a checklist 15cl for medical conditions (see FIG. 2a) as well as patient/health care provider conditions and situations (e.g., in verses out of network providers, patient information, etc.). An example of another checklist that can be used is shown in Appendix VI. This list is exemplary and in various embodiments, the order or content of this list can be varied, as needed depending, for example, on the physician's specialty (e.g. plastic surgery vs. general surgery) and the patient population (e.g. pediatric vs. geriatric).

In various embodiments, the contract module 12c, database 15 or matrix 15′ can be configured to perform one or more of the following functions: (i) ascertain that the patient has signed a contract with the SC; (ii) verify that patient is insured; (iii) identify the insurance carrier and the type and/or nature of coverage (deductibles, % coverage and the like); (iv) establish the status of the patient in relation to the insurer (e.g. group policy member etc); (v) establish that the selected physician is in or out of network and/or has signed a contract with the SC; (vi) inform the patient before the delivery who the surgeon is going to be and/or what the cost is going to be; (vii) inform the insurance company before the delivery what the cost is going to be and/or who the surgeon is going to be (viii) obtain approval from the insurance company before the delivery of care; and (ix) reach a contractual endpoint before the delivery of care.

Referring now to FIG. 2b, in a various embodiment, the system 10 and/or contract module 12c can be configured to generate and signal all or portions of a contract 20 from a first party 22 to one or more other parties 24 (and visa versa) over a network 16 such as the internet or communication means 16c described herein. Example parties 22 and 24 can include without limitation, the patient, the SC, the physician or health care provider. A specific embodiment includes signaling the contract 20 between a first party 22 and a second party 24′. Contract 20 can include selectable medical service parameters 23 selected by the parties. Parameters 23 can include without limitation, patient access, priority levels, medical practitioner response times to patient requests, reimbursement levels, pre-authorization levels (e.g. by procedure type or costs) and combinations thereof. Parameters 23 can be selected using contract module 12c or other module 12. Also, various data and other information can be entered into the contract electronically via coupling to databases such as databases 14 or 15, network 16 or through manual entry by any party.

Manual entry can include keyboards, touch screens, touch pads and the like, other I/O devices known in the art, voice recognition algorithms or scanning of handwritten documents using scanning methods known in the art. In one embodiment of a method of the invention, the contract database can be configured to be queried by the representative (e.g. office worker) of a surgeon or other medical care giver and the appropriate contract set can be electronically selected, generated and signed and/or executed by the physician or physician's representative and patient or alternatively can be printed out and signed by the physician and the patient. The signed contracts can then be electronically communicated or faxed to the SC. The appropriate contracts can then be scanned and saved into the database under the patient's name or other identifier such as social security number, birth date, or created identifier number or code. The SC can also secure the appropriate signed prepayment contracts from the insurer and also capture the data under the patient's name or other patient identifier (e.g. social security number, network number, insurance policy number etc).

Another embodiment of the invention, contract module 12c and or system 10 can be configured to for electronically entering into an agreement, such as a license, for the use of a proprietary or patented medical procedure by a medical practitioner. Thy system can be configured to select the agreement responsive to a selected medical service contract or medical procedure. The system can also be configured to select agreement parameters such as number of uses, site use etc and calculate licensing and related fees based on one more of the following methods: i) a fixed fee use by use basis; ii) a % royalty basis of the physicians fees; iii) a volume use basis (e.g. 10-20 uses); iv) a site license basis for the physician or physician group; and v) combinations thereof. System 10 and/or module 12c can be configured to allow the medical practitioner, or their representative, to select from a pool or database 15pp of available patented procedures which can be coupled to database 15 or matrix 15′.

Various embodiments of the invention can be configured to provide methods for a service organization or entity (e.g. the SC) to provide one or more of the following: online medical education, assistance as well as financial representation of the patient.

As described herein, in an embodiment, the patient can be captured or otherwise enrolled with the SC via a patient service contract which can include an electronically or carrier wave executed contract. Such a contract can be executed electronically using electronic signature and/or encryption methods known in the art. For ease of discussion, the contract 20 is an electronically executed contract but other embodiments are equally applicable. In various embodiments contract module 12c or other modules 12 can be configured to allow the contract to be executed between: i) the patient and the SC; ii) the patient and an IPA, or iii) the patient and another party.

Among a variety of functions, the patient care contract can serve to provide financial representation of the enrolled patient. In these and related embodiments, the contract can be configured (e.g., using module 12c) to include medical insurers and medical service providers. These and related embodiments can be configured to provide the ability of calculating or estimating out of pocket patient expenses (e.g., using module 12f) including physician and hospital co-payments and deductibles (hereafter co-payments) before the delivery of care. For surgeons and medical facilities that are not contracted with the SC, exclusive representation of the patient's financial interests can be pursued.

Before the delivery of care, related provider contracts can be obtained from other parties (e.g., an insurance company, surgeon and hospital/medical facility) and executed by the SC with those parties using electronic, computer or other signaling means described herein. In these related service contracts, the surgeon and hospital/facility can agree to limit co-pay percentages and deductible dollar amounts to usual or ‘in network’ percentages and deductible dollar amounts that are stipulated in the patient's policy using conventional means or electronic agreement and/or electronic signature means known in the art. (The capability to import, select and/or execute related provider contracts can be included in the contract module and can be performed using logic resources described herein or known in the art.) In consideration for this service, an addendum can be added to the contract by the contract module 12c which can stipulate that the patient will pay to the SC a percentage of any cost savings. For contracted surgeons, the SC can mutually represent the interests of the physician and patient. Where required by state, municipal or other statutes or guidelines, the SC can function as a management company for the contracting IPA. Where not required by statutes, the SC can directly contract with surgeons. The contract or systems can be configured to create a relationship between the surgeon and the patient where higher levels of reimbursement are provided to the surgeon through the establishment of an appropriate ‘allowed amount’ before the delivery of care and greater access of the patient to the provider of choice under terms of a usual or ‘in network’ co-payments, even though the surgeon and/or hospital/ facility may be deemed to be ‘out of network’ by the insurer. In this ‘out of network’ scenario, contracted surgeons and facilities can agree to charge only the usual or ‘in network’ co-payments. Furthermore, the related preferred provider contract (Appendix III) with the hospital/facility can be configured to require the hospital/facility to reduce the ‘out of network’ deductible charge to a usual or normal ‘in network’ deductible charge. In an embodiment of a method of the invention, system 10 and/or the contract module 12c or database 15 can configured to select a contract whereby the hospital/medical care facility (but not the contracted surgeon) absorbs the write-off between the ‘out of network’ and the ‘in network’ deductible charges.

With the patient care contract, incentives can be offered by the SC to the insurer to enter into a patient care contract (see Appendix I). Such incentives can include without limitation, financial, cost containment, labor efficiencies and the like because the patient and their employer can function as a persuasive intermediary before the delivery of care.

In an embodiment one or more proprietary and/or patented surgical procedures or methods can be made available through contract to participating surgeons, physicians and other health care providers. System 10 and/or contract module 12c can be configured to allow the medical practitioner to license such proprietary/patented procedures during contract selection or as a contract addendum on as needed basis with use fees calculable on an individual or a group or site license basis or other licensing method known in the art. The collection and use of such proprietary methods is described here in as Method Based Care and systems utilizing one or more such procedures are described as a Method Based Care System.

Accordingly, in embodiments utilizing Method Based Care, system 10 or modules 12 can be configured to notify the insurer that a license may be required if a proprietary surgical method is prior authorized and reimbursed at an allowed amount determined by the insurer. Also, in these and related embodiments, contract module 12c or other module 12 can be configured to require licensing of patented surgical procedures by the participating insurer as a means to provide additional incentive in negotiating an appropriate allowed amount or reimbursement level before the delivery of care. The negotiated level can be determined utilizing module 12f and/or module 12c or other module 12. In an embodiment, the negotiated level can be based in part on a royalty basis for use of the patented procedure.

Various embodiments of systems and methods of the invention can also be configured to reduce patient out of pocket expense during extended, complex or otherwise protracted delivery of medical care. Specifically in instances in which care is protracted or complex, the patient may also have out of pocket expenses reduced with a contracted global fee structure; the patient will not incur unforeseen co-payment expenses. In this instance, a savings to the patient is produced even though the surgeon co-payment is collected before the delivery of care. These and other embodiments of methods of the invention can be applied to any definitive care procedure including but not limited to surgical, out patient, minimally invasive, non-invasive procedures or a diagnostic procedures performed by the physician, nurse or other medical personnel including externally contracted personnel or services.

In various embodiments, the patient care contract or other contract can be made available and executed between the respective parties through the Internet or other distributed network using contract and electronic signature routines known in the art. In various embodiments, these functions can be performed by a contract or contract execution module. A contract module 12c for performing contract execution can include, but is not limited to, capabilities for viewing the contract, contract data entry and modification, electronic signature and financial transactions (e.g. consideration) between the respective parties. The processing and execution of the contracts can include electronic signature methods and/or encryption algorithms known in the art including but not limited to public and private key algorithms.

Another aspect of the invention can include an agreement between the physician and the medical service organization which can be electronically implemented utilizing system 10 or other electronic network means described herein or known in the art. Embodiments of this agreement are shown and described in Appendices I-IV. The agreement can be electronically implemented, for example, utilizing the contract module 12c or other module 12 described herein.

In an alternative embodiment, system 10 can be configured to allow the SC to directly function as an HMO. Although assignment of the patient into a company HMO would provide additional contract leverage with hospitals, a license as an HMO would be required.

Another embodiment of a method of the invention is configured to allow for the SC to function as a Health Care Plan or as an administrator of a Health Care Plan that is underwritten by a Third Party Insurance Carrier. Cost containment mechanisms (via electronic or other means described herein) will be selectively applied or segmented for the different components of the professional health care system. In an embodiment, ‘Segmented Cost Containment’ (or SC2) can be employed. This cost containment approach can include, but is not be limited to, the application of capitation or salaried compensation for primary care physicians. For diagnostic physicians such as radiologists and pathologists, and for ancillary services such as laboratory, a combination of cost containment mechanisms can be used. For routine diagnostic tests such as x-rays, CT-scans, mammography and the like as well as for the examination of pathology slides, capitation and/or salary compensation methods can be employed. For more complex diagnostic procedures, either case management review or a global fee structure can be applied as cost containment mechanisms. For surgery that is a more unique and/or a more complex singular event, a patient care contract can be consummated before the delivery of care (Appendix I). Prior to the procedure, the patient, insurer and surgeon can agree (using conventional or electronic means) to the allowed amount for the surgical procedure. The insurance benefit and the co-pay/deductible dollar amount that the patient must pay can be described in the patient care contract which can be configured to be viewed electronically including simultaneous viewing in multiple remote locations with real time editing and updating capability. Other embodiments of the contract can include terms for a commitment by all contracted parties to settle any outstanding legal disputes by either binding arbitration or by no fault settlement.

Whether the company functions independently of the insurance carrier or functions as a manager of a Health Care Plan that is underwritten by an insurer, embodiments of system 10 can be configured to allow the SC to obtain revenue from a variety of income sources. These revenue sources can include, but are not limited to, a percentage, or fixed fee of the contracted allowed amount that will be charged to the surgeon. To assist the collection of the SC's service fee, the co-pay can be initially paid to the SC by the patient before the delivery of care. Any amount of the paid co-pay that is above the SC's service fee can be held by the SC; a portion of that additional amount may be rebated by the SC to the surgeon at the end of the corporate year. Another potential source of revenue is for the SC to function as a pricing company for the insurance company or for the SC to function as an administrator of a Health Care Plan. The SC may also obtain additional revenue when functioning as an administrator of an IPA.

In various other embodiments of methods of the invention, system 10 can be configured to allow the SC to perform a variety of functional service components. These can include, but are not limited to, health care service provider and financial service provider. These functions can include or otherwise be facilitated by the use of Internet based websites and associated links to other health care web sites. Health care service provider functions can include the following website components: (i) links to websites with patient education brochures; (ii) links to “approved” health care websites for general information (e.g. ACS.org); and (iii) links to disease-based websites for more detailed information (e.g. the Peg Procedures for breast cancer).

A business model embodiment of method of the invention can include the capability for electronic recommendation (e.g. via the Internet or other means described herein) of patients to surgeons. These and related embodiments can be configured to provide an electronic marketing method for prospective host SC surgeons. Recommending a patient to a surgeon's practice can provide a convenient platform to demonstrate how the host SC will expand the surgeon's own practice among referring physicians within their own geographical area. Using an ‘out of network’ embodiment of system 10 or contract module 12c, surgeons can be able to regain access to these ‘out of network’ patients that they had been previously denied access by an insurance strategy that applies penalties or financially disincentives against patients that choose to obtain medical care outside of a restrictive ‘in network’ insurance ‘panel of physicians’. Expanded access to these ‘out of network’ patients can be provided to both the surgeon and to the patient, the latter who can now choose, without financial penalties, the procedure and surgeon of their own choice.

For the insurer who is now less advantaged when negotiating a per procedure patient care contract with the SC, an incentive can also be created to negotiate in good faith a more encompassing contract for surgical procedures involving all of their subscribers. In this embodiment, the SC can become a pricing company that may reduce overall reimbursement outlays by the insurer. Even though surgeon reimbursement may be enhanced, significant overall savings to the insurer may be provided by lowering or capping hospital/facility reimbursement through a preferred provider contract (see Appendix III). Embodiments utilizing this facility-preferred provider contract can be configured to allow the patient to only be charged the usual or normal in-network co-pay % and deductible amount. An in-network status can be granted to the patient, even if the patient is deemed out of network for any reason. System 10 or modules 12 can be configured to determine or update the co-pay based on input from one or more of the following (i) the SC, (ii) the physician, (iii) the patient's heath-plan, or (iv) the patient's insurance provider. Also in an embodiment, the system can be configured to update or determine co-pay as well as reasonable and customary charges by polling databases from one or more health plans or insurance carriers

In various embodiments, the host SC web sites, voice mail systems and other automated communications systems known in the art can be configured to allow for patient inquiries into their condition, symptoms, care options and other medical related questions. Patients can make inquires from email, voice mail or other electronic communications means known in the art using a personal computer, wireless PDA, cell phone or other handheld computer, telecommunication device or wireless device using communication protocols such as Blue-Tooth and other protocols for handheld wireless and telecommunication devices. The system can be configured to allow registered nurses to respond remotely to the patient either by phone, telecom, email and the like to discuss the patient's symptoms and answer their questions.

Referring to FIGS. 1, 3, 4 and 7, in various embodiments, system 10 can be configured to be used by registered nurse coordinators or other medical personnel to qualify and/or recommend surgeons to patients utilizing registration module 12reg, referral module 12rf or other module 12. These recommended surgeons can be selected based on their being credentialed at local hospitals in the patient's geographical area or at particular patient selected hospital or other surgical center (e.g. outpatient surgical units). These and other embodiments can be configured to allow the patient to select the both their physician and the medical facility for their surgery. The patient can also be informed which surgeons have access to the Method Based Care system.

In another embodiment, the nurse practitioner can be assisted in this process by use of triage module 12t (see FIG. 1). Triage module 12t can employ algorithms to perform a triage or ranking of patient medical conditions. Such algorithms can include without limitation artificial intelligence based algorithms, heuristic based diagnostic algorithms, or fuzzy logic based routines. Triage module 12t can also be configured to receive inputs and exchange data with a patient medical records database 14 and/or real-time medical data and/or images inputted from the telemedicine module 12tm. Online nursing triaging embodiments can be configured to eliminate the expense and time of an initial examination by a general practitioner and allowing these practitioners to focus on more medically urgent patients increasing their efficiency and providing more rapid response time to the medical urgent patient. The triage module can be configured to include a ranking system or set of parameters entered by the physician, nurse or other medical care provider or insurance company. This allows the medical practitioner to adjust or in effect fine tune the triage or prioritization conditions to a particular patient profile (e.g. age, state of health etc.) to improve the accuracy and efficiency of the triage functions for multiple health profiles. For example, a ranking system can be established for an obstetrics practice where patients are given a response ranking based on how close to term they are and/or if they have any potential medical complications (e.g. a weakened or prolapsed cervix, or are likely caesarian candidates). Also in an embodiment, the patient can select a level of service that allows them to have more direct or faster response times from the nurse practitioner or doctor via the SC communication network (e.g. web page, phone network etc). The fee for such service can be approximately inversely proportional to the assigned response time, projected response time or level of service. The determination of the fee can be mathematically determined using least squares, cubic spline, fuzzy logic or other modeling method known in the art.

Financial service provider embodiments of the system can include a general company introductory page or web site and an inquiry page or web site with linked email, voicemail and the like and combinations thereof. Patient inquiries generated from the website via email, voice mail or other communication means, can be responded to by an automatic email response which can be tailored to the patient's request, for example using a database or lookup table of answers to FAQ's. Patient inquiries can also be responded to by the office staff vial phone, email and the like and they can discuss the financial services that the SC can provide to patients who are considering surgery or other medical procedure. Particular embodiments can be adapted for patients with hearing, sight or other disabilities using accommodation technology known in the art including text telephone technology (e.g. TTY, or TDD), sip straw communication devices and the like. Financing sources for co-pay and deductible expenses can be made available to the patient.

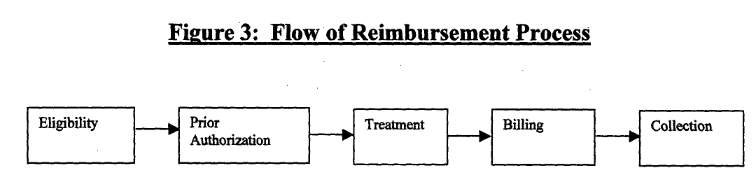

Other aspects and embodiments can be configured to provide a method for expediting reimbursement of the physician. Any delays in the delivery of care will be attributed to the insurer. Various embodiments can be configured to allow the SC to manage the entire reimbursement process or portions thereof. This process can be configured to link all components of the insurance reimbursement system/bureaucracy into a single pathway that can be monitored and updated as needed. This can be done electronically through one or more modules including the reimbursement and fee collection modules or manually or a combination of both. Components of the reimbursement pathway can be linked in sequence to the delivery of care as shown in FIG. 3. For surgeons (and/or surgery centers) who contract with the SC for total management of their reimbursement, a baseline/incremental relationship may be established. In an embodiment this baseline/incremental relationship can be determined using one or more formulas in Appendix IV (see Appendix IV: The Computational Model For Reimbursement, example formulas used to calculate reimbursement are described therein.).

A discussion will now be presented of embodiments of the invention in which the SC can serve as a service provider for patients considering surgery. These embodiments along with information about the SC's services can be implemented and/or communicated on the Internet via web pages and associated web page links. In these and related embodiments, the SC can serve as an Internet (or other electronic network) medical center of board certified surgeons. A function of the SC in such embodiments can be to assist the patient in obtaining the appropriate surgical procedure for his or her condition and system 10 can be configured accordingly. For example, during this decision making process, the SC can represent the patient's interests by coordinating a treatment plan with his or her surgeon, hospital and medical insurer. Detailed information on the indications, benefits and potential complications of any surgical procedure can be included as part of this service, where such service can be elected utilizing contract module 12c or contract matrix 15′. This information can be included on the web pages described herein. Descriptions of various surgical procedures can be provided in non-technical language that is configured to be easy to understand by the layman. The timing and urgency of the procedure as it relates to the patient's specific diagnosis can also discussed. Additional details such as the appropriate facility for the procedure and the length of recovery can be included. Further assistance can also be obtained from the nurse practitioner who can personally discuss the patient's symptoms with them. At no cost to the patient, the nurse practitioner can describe options of care and orient the patient to the appropriate surgical specialty that can most effectively treat their condition. To limit the patient's out of pocket expenses, the front office staff can also function as an effective contract interface with the surgeon and hospital of the patient's choice. If desired by the patient, the SC can also refer the patient's to a board certified surgeon for a second opinion. This second opinion service can also be complemented by the SC's proprietary contracting module. This financial service can be used by and configured for POS (point of service) patients who ultimately choose an “out of network” surgeon. A further description of such services and the layout of an embodiment of a web page are shown in Appendix V.

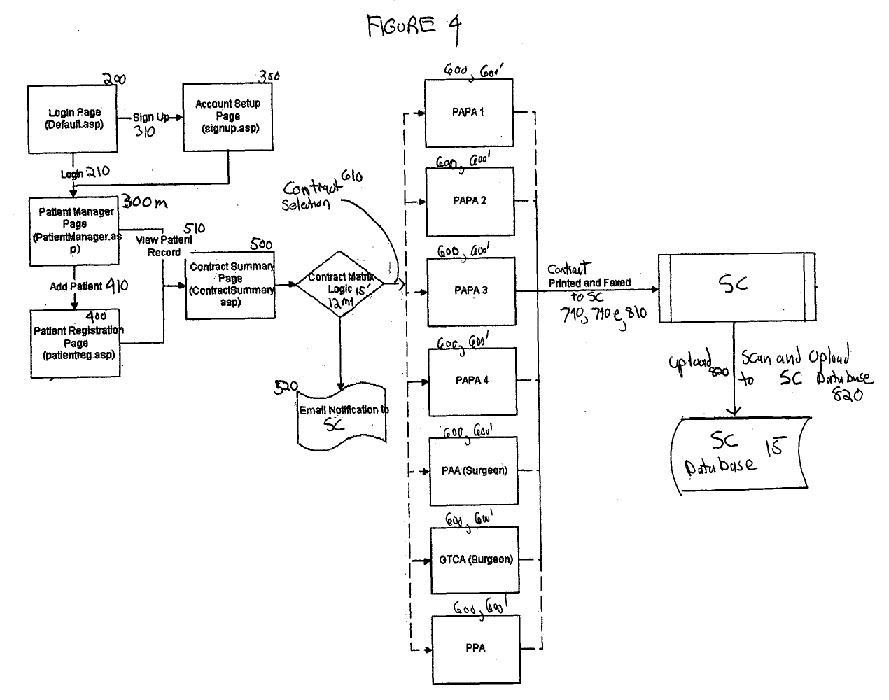

FIG. 4 illustrates an embodiment of a method or algorithm for the medical care provider to register or update a patient into system 10 and generate an appropriate contract using the Internet or other electronic network. Referring now to FIGS. 1, 2a, 2b and 4, utilizing an internet access device 18 (e.g. a computer terminal, PDA, etc) and web-browser 17, the care provider representative or pr (e.g. the patient manager) can access login page 200 and either directly login 210 into master module 12m or access account setup page 300 and perform a new account set up/sign up operation 310 by accessing the new account sign up module. Opening a new account on the system can involve entering various information such as physician taxpayer code, license #, address, and the like etc. Once signed up the pr can then login into module 12.

Once the pr has logged in or signed up, the pr can then access a patient or account manager page 300m to either add a patient 410 by accessing a patient registration page 400 or view a patient record 510 by going to the contract summary page 500 and accessing the contract module. The contract module 12c can then utilize contract matrix logic 12ml to perform a contract selection operation 610 to select and/or complete all or a portion of the appropriate contract 600 which can include a patent license or use contract.

In an embodiment, contract module 12c, based on input signaled from the pr, patient or other user, can be configured to use the contract matrix 15′ to select the appropriate contract to process. An example of a patient registration page is shown in Appendix V. This page can be configured to be accessed either by the pr, the patient or other user. The page can include one or more fields to allow the patient to enter information for purposes of registration, and determination of one or more of medical history, urgency of condition (e.g. for triage), insurance coverage and the like.

The contract module 12c or other module 12 can also be configured to perform an electronic notification step 520 to notify the SC of the contract selection event. Also the contract module can be configured to perform a contract printing 710 or electronic generation step 710e as well as a faxing or communication step 810 to fax or otherwise electronically send a copy of the completed contract 600′ to the SC. This can also be accomplished by making an electronic copy or digital image of the completed contract and sending it to the SC via email as an attached file. Once the contract is received by the SC, it can then be stored in the SC database 15 via an uploading step 820 which can include electronic scanning of the contract into an electronic file. Each step can have its own web page (with an associated URL) or alternatively, two or more steps can share a page or otherwise be linked to a common page. The web pages can be programmed using HTML, SGML or embedded JAVA based programming and the like and can include one or more hyperlinks to other pages and documents. Each page can include markups or links for forms (e.g. contracts) that can allow the user to fill out information and electronically send, or e-mail, the form to the SC or other party. Also the order of these steps is exemplary and other orders are equally applicable.

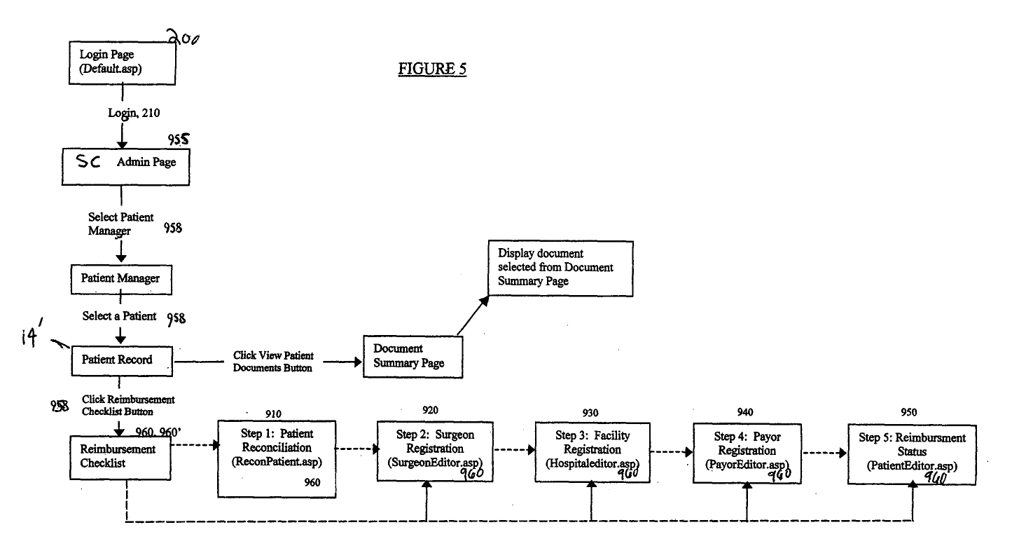

FIG. 5 illustrates an embodiment of a method or process for the SC or SC's representative to perform one or more registration or reimbursement related procedures over the Internet or other electronic or communications network. Such procedures include but are not limited to registering new patients, physicians, medical facilities and payers, as well as checking on the reimbursement status from the payer. Referring now to FIGS. 1 and 5, in an embodiment of a method for performing one or more of these operations, after logging into an administrative website 955 and performing one or more file management/access steps 958, one or more web pages 960, such as a reimbursement checklist page 960′ can be configured to allow the user to perform a patient reconciliation step 910, a surgeon registration step 920, a facility registration step 930, a payer registration step 940, and a reimbursement status check step 950. This order is but one configuration for this process and other orders are equally suitable, for example the surgeon registration step could be performed first or concurrently with one or more other steps. Also, each step can have its own web page or alternatively two or more steps can share a page or otherwise be linked to a common page. This can be accomplished by having separate fields for each step or nested or tiled fields using windowing/graphics routines known in the art. The order of these steps is exemplary and other orders are equally suitable.

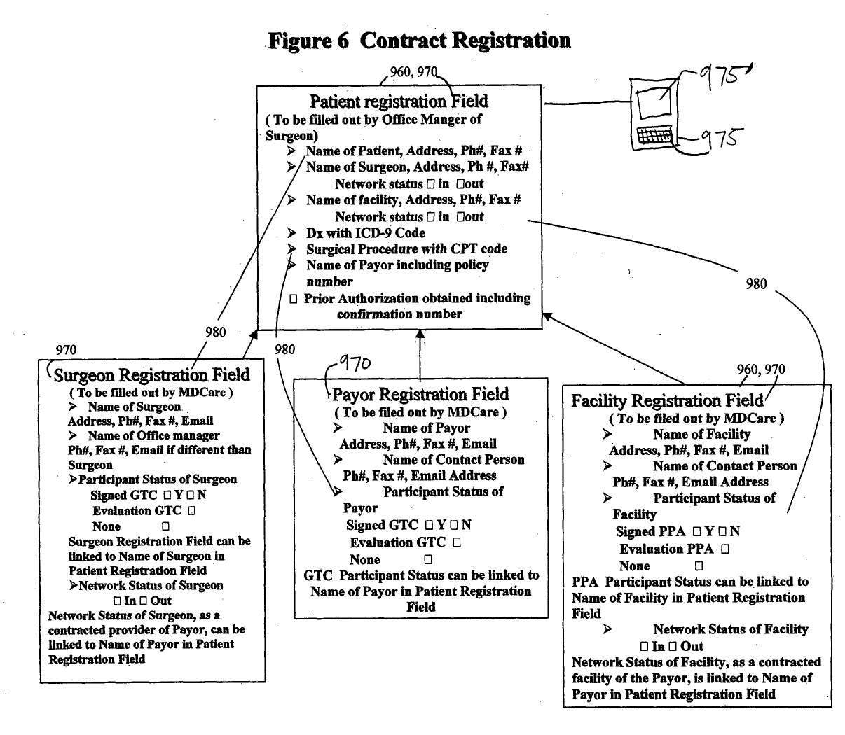

Referring now to FIG. 6, in various embodiments of system 10 including those implemented over the Internet, one or more modules 12 can configured to generate and/or display web pages 960 can include one or more fields 970 for entering and viewing information including, but not limited to, that for registering new patients, new physicians or facilities as well as other steps or operations described in the embodiment of FIGS. 4 and 5. Fields 970 can be configured to be accessed by one or more of the following: medical practitioners, medical practitioner representatives, SC representatives, facility representatives, or the patient. Also fields 970 can be configured to be accessed by standard input/output devices 975 known in the art including without limitation computers, keyboards, keypads, electronic/optical pointing devices (e.g., a mouse) and the like. Fields 970 can also be configured to be accessed via other I/O devices 975′ such as touch screens, touch pads, PDA screens, voice recognition devices and the like and combinations thereof. Also in various embodiments, one or more fields 970 can be linked (via hyperlinks, html or other addressable web page programming) to other fields on the same or different web page. Also multiple fields 970 can be displayed on the same web page or window 960. The figure also shows the configuration of one or more links (e.g. hyper links) 980 between fields 970.

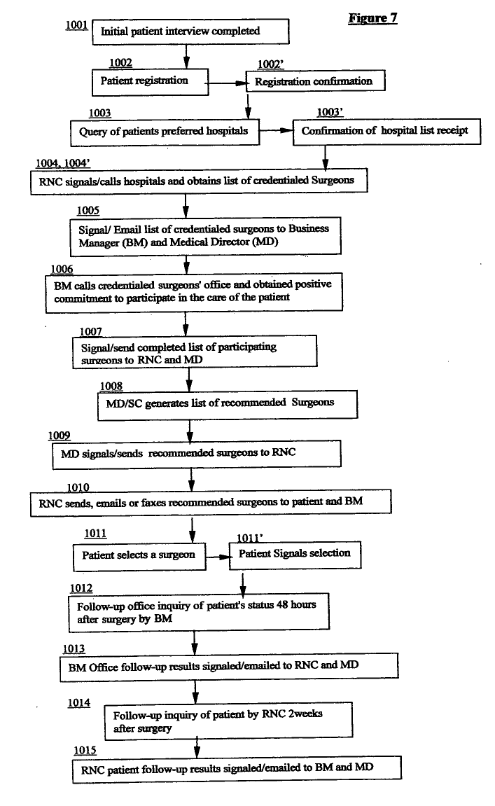

Referring now to FIG. 7, in other embodiments, system 10, registration module 12reg or other module 12 can be configured to allow the physician's nurse, assistant or other practitioner to enroll and process a new patient. An embodiment of a method that can be used by the nurse/practitioner to enroll a new patient utilizing registration module 12reg or module of system 10 is shown in FIG. 7 (also see Appendix VI). The procedure can include a patient interview step 1001 to gather medical, insurance, insurance preference, financial and other data either via electronic communication or manual entry. Step 1001 can then be followed by a registration step 1002 and a registration confirmation step 1002′ to confirm that the patient registration has been received can then be performed. Steps 1002 and 1002′ can then be followed by an inquiry step 1003 to determine the list of the patients preferred hospitals and a subsequent confirmation step 1003′. Steps 1003 and 1003′ can be done manually or electronically by polling patient medical and insurance databases and records. These can be accessed by system 10 via a network or they can be stored in the system on electronic media. Steps 1003 and 1003′ can then be followed by a step 1004 for the RNC to obtain (electronically or manually) a list of credentialed surgeons from the patient preferred hospitals and a subsequent confirmation step 1004′. Then a signaling step 1005 can be performed for the list of surgeons from step 1004 to a representative of the SC, such as a business manager (BM) or medical director (MD). Signaling can include, without limitation, emailing, phoning, telecommunication, fax communication, wireless communication, optical communication, RF communication and combinations thereof.

Signaling step 1005 can be done via email, network, RF means, phone, fax, optical means or other electromagnetic communication means known in the art. Signaling step 1005 can then be followed by a step 1006 for the SC representative to contact and obtain commitment from a participating surgeon to care for the patient. Step 1006 can be done electronically using email and the like and can employ contract module 12c to obtain a contractual obligation for the surgeon to care for the patient. Step 1006 can then be followed by a step 1007 to signal the list of participating surgeons to the RNC, MD or other representative of the SC. Step 1007 can be followed by a step 1008 whereby the MD generates a list of recommended surgeons. Step 1008 can then be followed by a step 1009 whereby the MD signals the list of recommended surgeons to one or more parties including the RNC. Step 1009 can then be followed by a step 1010 whereby the RNC signals the list of recommended surgeons to one or more parties including the patient and/or the BM. Step 1010 can then be followed by a step 1011 whereby the patient electronically selects a surgeon utilizing system 10 and/or subsequently signals that selection to one or more parties including SC in a signaling step 1011′. After the patient's surgery, step 1011 and 1011′ can be followed by a polling and/or inquiry step 1012 whereby a representative of the SC, such as the BM, polls or inquires (via electronic means) on the patient status from the selected surgeon, surgeons representative, surgeons computer or database and/or the patient. Step 1012 can be followed by a step 1013 whereby the BM or other SC representative signals (e.g. vial email) the patient status to RNC, MD or other SC representative. Step 1013 can then be followed by another patient inquiry step 1014 by the RNC or other representative and the patient status can be signaled to the BM or MD in a step 1015. The order of these steps is exemplary and other orders are equally applicable. Also one or more steps can be done using embodiments of system 10 configured for the Internet, World Wide Web or other computer or communications network known in the art or using a combination of computer and telecommunication means such as phone, voicemail and FAX. These and related patient processing procedures be done before, during, or after gathering and processing clinical information about the patient. Also to facilitate registration, system 10, module 12reg or other module 12 can be linked to a patient registration checklist, an example checklist being shown in Appendix VI.

Other embodiments of the invention can include methods, systems and apparatus by which the SC can serve as an Internet service provider for surgeons and their patients. In these and related embodiments, the SC functions as a medical services company that is dedicated to the private “fee for service” surgeon. In these embodiments the central corporate mission of the SC is to service the needs of the private surgeon with a full service reimbursement system that also generates new patient referrals. The SC's referral and reimbursement systems and methods can be configured to provide the ability to allow expansion of the physician's practice with new Internet referred patients and with patients that are referred within their own established network of referring physicians (see Appendix VIII ‘out of network rules’) that also raises their average per procedure reimbursement. These embodiments can include web pages configured for access and viewing by either the patient, the surgeon or both. Examples of web pages for the patient or for the surgeon are shown in Appendix VII. This appendix shows possible components of the websites including descriptive text, related links such as health care websites, fields/buttons to generate email and website diagrams which can illustrate medical procedures as well as one or more steps of the delivery of care to the patient. These components are exemplary and other embodiments can include a portion of these components as well as other web page components known in the art. In these and related embodiments system 10 can include referral, registration and reimbursement modules 12rf, 12reg and 12r. Also system 10 can include standard ISP protocols, and hardware (e.g. servers, T2, T3, DSL lines, Integrated Services Digital Networks and the like) to facility Internet communication between one or more surgeons and patients.

Related embodiments of systems and methods of the invention can be configured to provide for the development, education and/or practice of advanced surgical procedures through a Method Based Care system. The procedures that enhance patient outcomes can be highlighted in website descriptions that are displayed or otherwise configured to attract new patient referrals. A further description of such services and the layout of possible patient web pages are shown in Appendix VII. The websites can include information and/or links targeted to particular patient populations such as diabetics, oncology patients, patients desiring plastic surgery or patients requiring reconstructive surgery.

Embodiments of systems or methods of the invention can be configured to allow or facilitate insurance companies entering into an agreement shown in Appendix I for reimbursement of care to the patient or care provider prior to the delivery of care. They can be required to fulfill this agreement per the covenants of good faith under the appropriate state or other statutes for example, California Insurance Code § 790.03(h). Should the insurance company fail to make a good faith settlement or otherwise engage in unfair claims practices, the medical practitioner or patient can recover damages under the provisions of Code § 790.03(h) or other relevant or analogous state or federal code. The medical practitioner or patient can have the right to sue the insurance carrier under the appropriate state civil code or other statute, for example, California Civil Code provisions '2870 and 2871. In an embodiment, either the patient or the physician can have the option of assigning (for financial or other consideration) all or a portion of potential damages (actual, potential or consequential) for bad faith acts under the appropriate state or local code, for example, California Civil Code § 790.03(h) (or other state insurance or civil code) to a third party who may then bring suit against the insurance carrier or related party under the appropriate state or local code, for example, California Civil Code § 790.03(h) or other statute.

In yet another embodiment, the invention relates to a system 10 or network for preparing and processing health care data transactions such as medical insurance claims. In still yet another embodiment, the invention involves a computer system, and methods involving the same, applied to the financial fields of insurance and benefit funding. Specific embodiments can be configured to utilize automated and semi-automated aspects of an Indenture Agreement used to structure a pre-funding program for an employee benefit program. Embodiments of the invention further contemplate computer-assisted analysis and projection of the after-tax cash flow and the balance sheet and income statement consequences of the funding program, in connection with an illustration generated by the system.

Conclusion

It will be appreciated the applicants have provided novel systems and methods for providing a variety of services to the medical practitioner using computational and communication means described herein. Such services can include without limitation financial, business, legal and medical services. The systems and methods of the invention are adaptable for use with a variety of network, computer and telecommunication based systems. The foregoing description of various embodiments of the invention has been presented for purposes of illustration and description. It is not intended to limit the invention to the precise forms disclosed. Many modifications, variations and different combinations of embodiments will be apparent to practitioners skilled in the art. Further, elements from one embodiment can be readily recombined with one or more elements from other embodiments. Also, elements or acts from one embodiment can be readily substituted with elements or acts of another embodiment.

It is intended that the scope of the invention be defined by the following claims and their equivalents.

### Appendices

Various embodiments of the invention will now be further illustrated with reference to the following appendices. However, it will be appreciated that these appendices are presented for purposes of illustration and the invention is not to be limited to the information or the details therein. For example, the use of California and California statutes in one or more of the contracts in the appendices is exemplary and other states and statutes (e.g., state, local or Federal) are equally applicable.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for processing medical service contracts and transactions comprising:
a processor;
an interface module coupled to one of the processor or a network; and
a medical service contract module coupled to at least one of the interface module, or the processor, the contract module configured to be coupled to a contract matrix having a plurality of medical service contracts, the contract module configured to perform at least one of a contract selection function, a contract generation function or a contract execution function between a plurality of parties, the generation function including the generation of a contract having a selectable medical service parameter, wherein the contract module utilizes the contract matrix to perform the contract selection function, generation function or execution function responsive to at least one of a patient medical input, a financial input or an insurance input.

2. The system of claim 1, wherein the selectable medical service parameter includes at least one of an access level, a service level, a response time, a reimbursement level or a pre-authorization level.

3. The system of claim 1, wherein the contract module is configured to allow different groups of parties to enter into contract involving the delivery of a medical service or procedure to a patient.

4. The system of claim 1, wherein the network is at least one of a distributed network, a computer network, the Internet, a digital network, an optical network, a telecommunications network, a phone network or a wireless communication network.

5. The system of claim 1, wherein the system is configured to communicate at least one of an input or an output utilizing at least one of the Internet or an Internet web page.

6. The system of claim 1, wherein at least a portion of the system is configured to be implemented by carrier wave communication.

7. The system of claim 1, further comprising:
a financial transaction processing module coupled to the processor, the transaction processing module configured to perform at least one of a fee calculation, a procedure fee calculation, a baseline fee calculation, a co-payment determination, or a reimbursement calculation.

8. The system of claim 7, further comprising:
a financial database including a plurality of records, at least one record of the plurality including medical financial data, the financial database coupled to at least one of the financial transaction module, the interface module, the contract module or the processor.

9. The system of claim 1, further comprising:
a medical database including a plurality of records, at least one record of the plurality including patient medical data, the database coupled to at least one of the interface module, the contract module or the processor, wherein the contract module is configured to generate the contract responsive to an input from the medical database.

10. The system of claim 1, wherein the plurality of parties includes a patient and a company financially negotiating for the patient.

11. The system of claim 1, wherein the plurality of parties includes a medical practitioner and a company financially negotiating for the practitioner.

12. The system of claim 1, wherein the plurality of parties includes at least one of a patient, a physician, a medical practitioner, a corporation, a health care corporation, a health care service corporation, a hospital, a health maintenance organization, a health care provider organization, an insurance company or a third party payer.

13. The system of claim 1, wherein the contract module is configured to determine one of a patient service level, a patient access level to a medical practitioner, a response time to a patient inquiry or a patient co-payment level, the determination responsive to a financial input.

14. The system of claim 1, further comprising:
a medical triage module coupled to at least one of the interface module or the processor, the triage module configured to determine a patient response priority to at least one of signaled medical data, or a selectable medical profile.

15. The system of claim 1, wherein at least one of the system, the contract module or the interface module is configured to electronically obtain a medical procedure pre-authorization from one of an insurance carrier, a patient or a health care provider.

16. The system of claim 1, wherein the contract module is configured to generate a first contract and to generate a second contract responsive to at least one of the first contract or to the plurality of parties in the first contract.

17. The system of claim 1, wherein the contract module is configured to signal an execution of a contract or a contracted payment to at least one of a contracting party or a non-contracting party.

18. The system of claim 1, further comprising:
a referral module, the referral module configured to electronically refer a patient to a medical practitioner or the practitioner to the patient, the referral responsive to at least one of a patient medical profile or a practitioner profile.

19. The system of claim 1, wherein the contract module is configured to allow the selection and execution of a contract for the use of a patented medical procedure from a database of patented medical procedures.

20. The system of claim 1, further comprising:
a reimbursement module coupled to at least one of the processor, the contract module or the interface module, the reimbursement module configured to determine a reimbursement level for at least one of a health care provider, a contracted health care provider or a party in contract with the health care provider.

21. The system of claim 20, wherein the reimbursement module is configured to determine the reimbursement level responsive to at least one of a selected contract, the medical input, the financial input or the insurance input.

22. The system of claim 20, wherein the reimbursement module is configured to signal the reimbursement level to the health care provider or a party in contract with the health care provider.

23. The system of claim 1, wherein the contract matrix is configured to be used as a checklist for entry of a party into a medical service contract or a medical service plan.

24. A system for processing medical service contracts and transactions comprising:
a processor;
an interface module coupled to one of the processor or a network; and
a medical service contract module coupled to at least one of the interface module or the processor, the contract module configured to be coupled to a contract matrix, the contract module configured to perform at least one of a contract selection function or a contract execution function between a plurality of parties, wherein the contract module utilizes the contract matrix to perform the contract selection function or execution function responsive to at least one of a patient medical input, a financial input or a insurance input, and the contract module assigns a service level to a patient responsive to at least one of the medical input, the financial input or the insurance input.

25. A method for processing medical transactions comprising:
signaling data between a first party and a second party, wherein the data includes at least one of financial data, medical data or insurance data;
generating a medical service contract having a medical service parameter utilizing at least one of a contract matrix or a contract module configured to allow multiple groups of parties to enter into contract for the delivery of medical service to a patient, the generation responsive to at least one of the financial data, the medical data or the insurance data, at least one of the module or the matrix configured to be coupled to at least one of a processor or a network;
signaling the contract between the first party and the second party; and
executing the contract utilizing at least one of the module, the processor or the network.

26. The method of claim 25, further comprising
executing the contract between the first party and at least one of the second party or a third party.

27. The method of claim 25, further comprising:
selecting the contract from the contract matrix utilizing at least one of the processor, the module or the network, the selection responsive to at least one of the financial data, the medical data, the insurance data, the service parameter or a relationship between the parties.

28. The method of claim 25, further comprising:
negotiating a reimbursement level utilizing at least one of the module, the processor or the network, the negotiation responsive to a party having a right to a patent or a medical procedure patent.

29. The method of claim 25, wherein the medical service parameter is at least one of a patient priority level, a patient service level, a response time, a payment level, a reimbursement level, a medical condition, a medical profile or a preauthorization status.

30. The method of claim 25, further comprising:
generating a contract for use of a patented medical procedure utilizing at least one of the module, the processor or the network; and
executing the contract for use of the patented procedure utilizing at least one of the module, the processor or the network.

31. The method of claim 30, further comprising:
selecting the patented medical procedure from a database of patented procedures utilizing at least one of the module, the processor or the network.

32. The method of claim 25, further comprising:
enrolling a patient into a medical service plan utilizing at least one of the processor, the module or the network, the enrolment responsive to at least one of the financial data, the medical data, the insurance data or the service parameter utilizing at least one of the processor, the module or the network.

33. The method of claim 25, further comprising:
updating or viewing at least one of the contract or a patient record utilizing at least one of the processor, the module or the network.

34. The method of claim 25, further comprising:
determining a patient's insurance coverage or eligibility utilizing at least one of the processor, the module, the network or a database.

35. The method of claim 34, wherein determination is done prior to at least one of contract generation or a delivery of medical service to the patient.

36. The method of claim 25, further comprising:
determining at least one of a fee, a co-payment level or a global fee structure for a medical service or procedure utilizing at least one of the processor, the module or the network, the determination responsive to at least one of a patient service level, a patient response time, financial data, medical data, baseline medical revenue data or data polled from a database.

37. The method of claim 25, further comprising:
determining a reimbursement level for a medical service or procedure utilizing at least one of the processor, the module or the network, the determination responsive to at least one of the medical service parameter, financial data, medical data, baseline medical revenue data or data polled from a database.

38. The method of claim 25, further comprising:
obtaining or signaling a procedure pre-authorization between at least two parties.

39. The method of claim 38, wherein the pre-authorization is signaled from an insuring party to one of a health care provider, a medical practitioner or a contracted party.

40. The method of claim 25, further comprising:
signaling a payment or a reimbursement level between at least two parties.

41. The method of claim 40, wherein the payment or reimbursement level is signaled from an insurance company to at least one of a health care provider, a non-health care provider or a contracted party.

42. The method of claim 25, wherein the first party is a company and the second party is one of a patient, an insurance company, a hospital, or a health maintenance organization.

43. The method of claim 25, wherein the first party is a company and the second party is one of a physician, a physician group, a surgeon or a medical practitioner.

44. The method of claim 25, wherein the contract is signaled using email, encrypted email, a carrier wave, an encrypted carrier wave or an encryption algorithm.

45. The method of claim 25, wherein the contract is executed using an electronic signature.

46. The method of claim 25, further comprising:
signaling an approval for a medical procedure between at least two parties.

47. The method of claim 25, further comprising:
signaling reimbursement data between at least two parties.

48. The method of claim 25, further comprising:
referring a patient to a medical practitioner utilizing at least one of the processor, the module or the network, the referral responsive to at least one of a patient medical profile or a medical practitioner profile.

49. The method of claim 25, further comprising:
referring a medical practitioner to a patient utilizing at least one of the processor, the module or the network, the referral responsive to at least one of a patient medical profile or a medical practitioner profile.

50. The method of claim 25, further comprising:
signaling a contracted party when a patient has been referred to a medical practitioner or has contracted with a medical practitioner.

51. The method of claim 25, further comprising:
assigning a response priority to a patient utilizing at least one of the processor, the module or the network, the assignment responsive to at least one of the medical or financial data.

52. The method of claim 51, further comprising:
signaling a response to a patient inquiry utilizing the response priority.

53. A method for enrolling a patient into a medical service plan comprising:
creating a patient electronic file having a plurality of records;
entering at least one of medical, financial or insurance data into a record of the plurality of records;
selecting a medical service contract from a contract matrix using a contract module coupled to a processor, the selection responsive to at least one of the medical, financial or insurance data;
executing the contract with the patient and a medical service provider utilizing the module; and
signaling the contract to at least one of the patient, the medical service provider or another party.

54. A method for processing medical transactions comprising:
signaling data between a first party and a second party, wherein the data includes at least one of financial or medical data;
selecting a medical service contract having a medical service parameter utilizing a processor, the selection responsive to at least of the financial or medical data or a patient service level;
signaling the contract between the first party and the second party; and
executing the contract utilizing the processor.

55. The method of claim 54, further comprising:
generating a contract for use of a patented medical procedure utilizing the processor; and
executing the contract for use of the patented procedure utilizing the processor.

56. The method of claim 55, further comprising:
selecting the patented medical procedure from a database of patented procedures utilizing the processor.

57. A method for processing medical transactions comprising:
signaling data between a first party and a second party, wherein the data includes at least one of financial or medical data;
generating a medical service contract for use of a patented medical procedure utilizing a processor, the generation responsive to at least one of financial or medical data;
signaling the contract between the first party and the second party; and
executing the contract utilizing the processor.

58. The method of claim 57, further comprising:
selecting the patented medical procedure from a database of patented procedures utilizing the processor.
